(19) United States
(12) Patent Application Publication
(10) Pub. No.: US 2025/0346739 A1
(43) Pub. Date: Nov. 13, 2025

(54) Reinforced Polyoxymethylene Polymer Compositions

(71) Applicant: Celanese International Corporation, Irving, TX (US)

(72) Inventors: Kirsten Markgraf, Weinheim (DE); Sabine Steinbach, Kelkheim (DE); Elisabeth Nowottny, Frankfurt (DE)

(21) Appl. No.: 19/194,931

(22) Filed: Apr. 30, 2025

Related U.S. Application Data
(60) Provisional application No. 63/645,183, filed on May 10, 2024.

(51) Int. Cl. C08K 9/04; C08G 18/10; C08G 18/56; C08G 18/80; C08J 3/20; C08K 5/3492

(52) U.S. Cl. CPC C08K 9/04; C08G 18/10; C08G 18/56; C08G 18/80; C08J 3/203; C08K 5/34922; C08J 2375/08

(57) ABSTRACT

Fiber reinforced polyoxymethylene polymer compositions are disclosed. A coupling agent is included in the composition for compatibilizing or forming bonds between the reinforcing fibers or a size composition on the reinforcing fibers and the polyoxymethylene polymer. In one embodiment, a latent coupling agent is contained in the sizing composition on the reinforcing fibers. In an alternative embodiment, a coupling agent-enriched polymer is added to the composition. Physical properties are dramatically improved without having to add any free isocyanate compounds.

### BACKGROUND

Polyacetal polymers, which are commonly referred to as polyoxymethylene polymers, have become established as exceptionally useful engineering materials in a variety of applications. Polyoxymethylene polymers, for instance, are widely used in constructing molded parts, such as parts for use in the automotive industry and in the electrical industry. Polyoxymethylene polymers, for instance, have excellent mechanical properties, fatigue resistance, abrasion resistance, chemical resistance, and moldability.

In some applications, polyoxymethylene polymers are combined with reinforcing fibers in order to increase certain mechanical properties, such as tensile strength. In the past, various attempts have been made in order to couple the reinforcing fibers to the polyoxymethylene polymer in the polymer matrix. For instance, in the past, various coupling agents have been added to the composition in order to couple the glass fibers to the polyoxymethylene polymer. For instance, isocyanates have been used in the past as coupling agents, such as diisocyanates and polyisocyanates.

Adding isocyanate coupling agents into the polymer composition during the formation of molded articles, however, can be problematic. The coupling agent, for instance, should be added in controlled amounts. The handling and addition of the coupling agent to the molten polymer mixture is difficult and has created problems in the past.

In view of the above, a need exists for a fiber reinforced polymer composition with increased tensile properties without having to add an isocyanate, such as a diisocyanate, directly into the composition.

### SUMMARY

In general, the present disclosure is directed to a polymer composition containing a polyoxymethylene polymer containing reinforcing fibers. Once the composition is molded into an article, the reinforcing fibers become coupled to the polyoxymethylene polymer without having to directly add free amounts of an isocyanate, such as a diisocyanate or a polyisocyanate. Instead, isocyanate functional groups are added to the polymer composition in a latent state as part of a sizing composition applied to the reinforcing fibers or can be added as functional groups on a polymer. Once the polymer composition is heated into a molten state, the isocyanate functional groups become available for coupling the reinforcing fibers to the polyoxymethylene polymer.

In one embodiment, for instance, the present disclosure is directed to a polymer composition containing a polyoxymethylene polymer. The polyoxymethylene polymer is present in the composition in an amount greater than about 30% by weight, such as in an amount greater than about 40% by weight, such as in an amount greater than about 50% by weight, such as in an amount greater than about 60% by weight, such as in an amount greater than about 70% by weight, and in an amount less than about 90% by weight, such as in an amount less than about 80% by weight. In accordance with the present disclosure, the polyoxymethylene polymer includes terminal reactive groups, such as terminal hydroxyl groups that facilitate coupling of the polyoxymethylene polymer to the reinforcing fibers. For instance, in one embodiment, the polyoxymethylene polymer contains terminal hydroxyl groups in an amount greater than about 10 mmol/kg, such as greater than about 20 mmol/kg, such as greater than about 30 mmol/kg, such as greater than about 40 mmol/kg, such as greater than about 50 mmol/kg.

The polymer composition also contains reinforcing fibers, such as glass fibers. The reinforcing fibers can be present in the polymer composition in an amount from about 5% to about 50% by weight, such as in an amount from about 10% to about 40% by weight, such as in an amount from about 20% to about 35% by weight. A sizing composition is present on a surface of the reinforcing fibers.

In accordance with the present disclosure, the polymer composition also contains a latent coupling agent combined within the sizing composition on the reinforcing fibers, contains a polymer, such as a polyurethane polymer, that is enriched with isocyanate functional groups, or contains a mixture of both. The latent coupling agent contained within the sizing composition, for instance, can comprise a blocked isocyanate that, when heated, couples the glass fibers to the terminal hydroxyl groups on the polyoxymethylene polymer. The isocyanate enriched polymer, on the other hand, can comprise a blend or masterbatch of the polymer and a crosslinking agent that may comprise isocyanate groups that also couple the glass fibers to the terminal hydroxyl groups on the polyoxymethylene polymer. The crosslinking agent-enriched polymer, for instance, can be present in the polymer composition in an amount from about 0.1% by weight to about 25% by weight, such as in an amount from about 0.1% by weight to about 10% by weight, such as in an amount from about 0.5% by weight to about 8% by weight. In one aspect, the crosslinking agent combined with or contained in the polymer can form crosslinks within the polymer matrix. For instance, the functional groups on the crosslinking agent can be bi-functional and/or tri-functional.

The polymer composition of the present disclosure can display excellent physical properties. For instance, the polymer composition can have excellent flow properties displaying a melt flow rate of greater than about 2.5 g/10 min, such as greater than about 3 g/10 min, and less than about 20 g/10 min. When containing the blocked isocyanate in the sizing composition, the polymer composition can display a notched Charpy impact strength resistance at 23° C. of greater than about 9 KJ/m², such as greater than about 10 KJ/m², such as greater than about 12 KJ/m². When containing the polymer with functional groups, on the other hand, the polymer composition can display a notched Charpy impact strength resistance at 23° C. of greater than about 16 KJ/m², such as greater than about 17 KJ/m², such as greater than about 18 KJ/m², and can display a notched Charpy impact strength resistance at −30° C. of greater than about 15 KJ/m², such as greater than about 16 kJ/m², such as greater than about 17 KJ/m². The polymer with functional groups, for instance, can have a dual purpose and can also serve to increase impact resistance.

The polymer composition of the present disclosure can display a tensile modulus of greater than about 8,000 MPa, such as greater than about 8,500 MPa, such as greater than about 8,800 MPa. The polymer composition can display a break stress of greater than about 140 MPa, such as greater than about 145 MPa, such as greater than about 150 MPa.

The polymer composition can also display a relatively low formaldehyde emission. For instance, the polymer composition can display a formaldehyde emission when tested according to Test VDA 275 of less than about 7 ppm. The polymer composition can optionally contain a formaldehyde scavenger, such as melamine.

The present disclosure is also directed to a process for producing molded articles. The process includes combining a polyoxymethylene polymer containing terminal hydroxyl groups as described above with reinforcing fibers that include a coating of a size composition. In one aspect, the size composition can contain a blocked isocyanate. In another aspect, the polymer composition can contain a polymer, such as a polyurethane polymer, enriched with a crosslinking agent and/or isocyanate functional groups. In still another embodiment, the polymer composition can contain both a blocked isocyanate within the sizing composition and a crosslinking agent-enriched polymer. The polymer composition is heated to a molten state which causes the reinforcing fibers to couple to the hydroxyl terminal groups on the polyoxymethylene polymer. The polymer composition is molded into an article using any suitable molding process, such as injection molding, extrusion, blow molding, and the like.

Other features and aspects of the present disclosure are discussed in greater detail below.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer composition containing reinforcing fibers having enhanced mechanical properties. The polymer composition contains a polyoxymethylene polymer in an amount sufficient to form a polymer matrix within molded articles made from the composition. The reinforcing fibers can comprise glass fibers and are coated with a sizing composition. In one aspect, the polyoxymethylene polymer includes terminal reactive groups, such as terminal hydroxyl groups. In accordance with the present disclosure, a coupling technology is incorporated into the polymer composition that couples the reinforcing fibers to the terminal reactive groups on the polyoxymethylene polymer. The coupling technology can comprise a reactive sizing composition present on the surface of the reinforcing fibers, can comprise the addition of an isocyanate-enriched polymer, such as an isocyanate-enriched thermoplastic polyurethane polymer masterbatch, or can comprise a combination of both.

The polymer composition of the present disclosure is well suited for coupling the reinforcing fibers to the polyoxymethylene polymer without having to add any other coupling agents to the polymer composition. For instance, the polymer composition can be formulated without having to add free amounts of an isocyanate, such as a diisocyanate or a polyisocyanate. In this manner, an isocyanate coupling agent does not have to be handled and added to the other components which can lead to processing inefficiencies and special handling requirements.

As described above, the polymer composition of the present disclosure contains a polyoxymethylene polymer that contains reactive groups capable of coupling to the reinforcing fibers or to a size composition on the reinforcing fibers. The polyoxymethylene polymer may comprise a homopolymer or a copolymer.

The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. The polyoxymethylene polymer used in the polymer composition may comprise a homopolymer or a copolymer. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.1 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

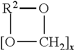

in which x is 0 or 1 and R² is a C₂—C₄-alkylene group which, if appropriate, has one or more substituents which are C₁—C₄-akyl groups, or are C₁—C4-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo-or polyformals, such as polydioxolane or polydioxepan, as comonomers. It is particularly advantageous to use copolymers composed of from 99.5 to 95 mol. % of trioxane and of from 0.5 to 5 mol. %, such as from 3 to 4 mol. %, of one of the above-mentioned comonomers.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

In one embodiment, the polyoxymethylene polymer used in the polymer composition may contain a relatively high amount of reactive groups or functional groups in the terminal position. The reactive groups or functional groups can comprise any groups that are capable of forming a bond with a coupling agent. The reactive groups, for instance, may comprise —OH or —NH₂ groups or the like.

In one embodiment, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 10 mmol/kg, such as at least 15 mmol/kg, such as at least 20 mmol/kg. For example, the polyoxymethylene polymer can have a content of terminal hydroxyl groups of greater than about 25 mmol/kg, such as greater than about 30 mmol/kg, such as greater than about 35 mmol/kg, such as greater than about 40 mmol/kg, such as greater than about 45 mmol/kg, such as greater than about 50 mmol/kg, such as greater than about 60 mmol/kg, such as greater than about 70 mmol/kg, such as greater than about 80 mmol/kg. The content of terminal hydroxyl groups on the polyoxymethylene polymer is generally less than about 300 mmol/kg, such as less than about 200 mmol/kg.

The portion of terminal OH groups in POM is determined as described in K. Kawaguchi, E. Masuda, Y. Tajima, Journal of Applied Polymer Science, Vol. 107, 667-673 (2008).

In addition to the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo-or copolymer which comprises at least 50 mol-%, such as at least 75 mol-%, such as at least 90 mol-% and such as even at least 95 mol-% of —CH₂O-repeat units.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2 wt. %.

A heteropoly acid refers to polyacids formed by the condensation of different kinds of oxo acids through dehydration and contains a mono- or poly-nuclear complex ion wherein a hetero element is present in the center and the oxo acid residues are condensed through oxygen atoms. Such a heteropoly acid is represented by the formula:

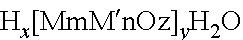

wherein
M represents an element selected from the group consisting of P, Si, Ge, Sn, As, Sb, U, Mn, Re, Cu, Ni, Ti, Co, Fe, Cr, Th or Ce,
M′ represents an element selected from the group consisting of W, Mo, V or Nb,
m is 1 to 10,
n is 6 to 40,
z is 10 to 100,
x is an integer of 1 or above, and
y is 0 to 50.

The central element (M) in the formula described above may be composed of one or more kinds of elements selected from P and Si and the coordinate element (M′) is composed of at least one element selected from W, Mo and V, particularly W or Mo.

Specific examples of heteropoly acids are phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstovanadic acid and acid salts thereof. Excellent results have been achieved with heteropoly acids selected from 12-molybdophosphoric acid (H₃PMo₁₂O₄₀) and 12-tungstophosphoric acid (H₃ PW₁₂O₄₀) and mixtures thereof.

The heteropoly acid may be dissolved in an alkyl ester of a polybasic carboxylic acid. It has been found that alkyl esters of polybasic carboxylic acid are effective to dissolve the heteropoly acids or salts thereof at room temperature (25° C.).

The alkyl ester of the polybasic carboxylic acid can easily be separated from the production stream since no azeotropic mixtures are formed. Additionally, the alkyl ester of the polybasic carboxylic acid used to dissolve the heteropoly acid or an acid salt thereof fulfills the safety aspects and environmental aspects and, moreover, is inert under the conditions for the manufacturing of oxymethylene polymers.

Preferably the alkyl ester of a polybasic carboxylic acid is an alkyl ester of an aliphatic dicarboxylic acid of the formula:

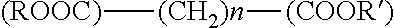

wherein
n is an integer from 2 to 12, preferably 3 to 6 and
R and R′ represent independently from each other an alkyl group having 1 to 4 carbon atoms, preferably selected from the group consisting of methyl, ethyl, n-propyl, iso-propyl, n-butyl, iso-butyl and tert.-butyl.

In one embodiment, the polybasic carboxylic acid comprises the dimethyl or diethyl ester of the above-mentioned formula, such as a dimethyl adipate (DMA).

The alkyl ester of the polybasic carboxylic acid may also be represented by the following formula:

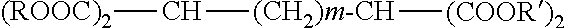

wherein
m is an integer from 0 to 10, preferably from 2 to 4 and
R and R′ are independently from each other alkyl groups having 1 to 4 carbon atoms, preferably selected from the group consisting of methyl, ethyl, n-propyl, iso-propyl, n-butyl, iso-butyl and tert.-butyl.

Particularly preferred components which can be used to dissolve the heteropoly acid according to the above formula are butantetracarboxylic acid tetratethyl ester or butantetracarboxylic acid tetramethyl ester.

Specific examples of the alkyl ester of a polybasic carboxylic acid are dimethyl glutaric acid, dimethyl adipic acid, dimethyl pimelic acid, dimethyl suberic acid, diethyl glutaric acid, diethyl adipic acid, diethyl pimelic acid, diethyl suberic acid, diemethyl phthalic acid, dimethyl isophthalic acid, dimethyl terephthalic acid, diethyl phthalic acid, diethyl isophthalic acid, diethyl terephthalic acid, butantetracarboxylic acid tetramethylester and butantetracarboxylic acid tetraethylester as well as mixtures thereof. Other examples include dimethylisophthalate, diethylisophthalate, dimethylterephthalate or diethylterephthalate.

Preferably, the heteropoly acid is dissolved in the alkyl ester of the polybasic carboxylic acid in an amount lower than 5 wt. %, preferably in an amount ranging from 0.01 to 5 wt. %, wherein the weight is based on the entire solution.

In some embodiments, the polymer composition of the present disclosure may contain other polyoxymethylene homopolymers and/or polyoxymethylene copolymers. Such polymers, for instance, are generally unbranched linear polymers which contain at least 80%, such as at least 90% oxymethylene units.

The polyoxymethylene polymer can have any suitable molecular weight. The molecular weight of the polymer, for instance, can be from about 4,000 grams per mole to about 20,000 g/mol. In other embodiments, however, the molecular weight can be well above 20,000 g/mol, such as from about 20,000 g/mol to about 500,000 g/mol, such as from about 50,000 g/mol to about 300,000 g/mol.

The polyoxymethylene polymer may be present in the polyoxymethylene polymer composition in an amount of at least 30 wt. %, such as at least 35 wt. %, such as at least 40 wt. %, such as at least 45 wt. %, such as at least 50 wt. %, such as at least 60 wt. %, such as at least 70 wt. %, such as at least 80 wt. %. In general, the polyoxymethylene polymer is present in an amount of less than about 90 wt. %, such as less than about 85 wt. %, such as less than about 80 wt. %, wherein the weight is based on the total weight of the polyoxymethylene polymer composition.

The polyoxymethylene polymer can have any suitable melt flow rate. The melt flow rate of the polyoxymethylene polymer, for instance, can be from about 1 g/10 min to about 100 g/10 min, including all increments of 1 g/10 min therebetween. In one embodiment, the polymer can have a lower melt flow rate. For instance, the melt flow rate can be less than about 35 g/10 min, such as less than about 30 g/10 min, such as less than about 25 g/10 min, such as less than about 20 g/10 min, such as less than about 15 g/10 min, such as less than about 10 g/10 min. The melt flow rate of the polymer can be greater than about 1 g/10 min, such as greater than about 2 g/10 min, such as greater than about 5 g/10 min, such as greater than about 9 g/10 min, such as greater than about 15 g/10 min.

In one aspect, a relatively high melt flow rate polymer may be used. For instance, the polyoxymethylene polymer can have a melt flow rate of greater than about 35 g/10 min, such as greater than about 40 g/10 min, and less than about 80 g/10 min, such as less than about 70 g/10 min, such as less than about 50 g/10 min, such as less than about 40 g/10 min. Melt flow rate of the polyoxymethylene polymer in the overall polymer composition is determined according to ISO Test 1133 at 190° C. and at a load of 2.16 kg.

The polymer composition also contains reinforcing fibers which can comprise mineral fibers, such as glass fibers, metal fibers, such as steel fibers, carbon fibers, or mixtures thereof. The reinforcing fibers can also comprise polymer fibers, such as aramid fibers.

The reinforcing fibers can be present in the polymer composition in an amount from about 5% by weight to about 55% by weight. For instance, the reinforcing fibers can be present in the polymer composition in an amount greater than about 10% by weight, such as in an amount greater than about 15% by weight, such as in an amount greater than about 20% by weight, such as in an amount greater than about 23% by weight, and in an amount less than about 50% by weight, such as in an amount less than about 45% by weight, such as in an amount less than about 40% by weight, such as in an amount less than about 35% by weight, such as in an amount less than about 33% by weight. The reinforcing fibers, such as glass fibers, can include a sizing composition applied to or coated over a surface of the fibers. The sizing composition can comprise silanes, film forming agents, lubricants, wetting agents, adhesive agents, antistatic agents, plasticizers, emulsifiers, and the like.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are, for example, polyvinylacetates, polyesters and polyurethanes. Sizings based on polyurethanes may be used advantageously.

In accordance with one embodiment of the present disclosure, the sizing composition applied to the reinforcing fibers can also contain a latent coupling agent. The latent coupling agent can become active when heated and couple the sizing composition to the reactive groups or hydroxyl groups on the polyoxymethylene polymer. For instance, in one embodiment, the latent coupling agent can form crosslinks between the polyoxymethylene polymer and a surface of the reinforcing fibers. The latent coupling agent, for instance, may constitute from about 5% by weight to about 90% by weight, such as from about 10% by weight to about 80% by weight, such as from about 15% by weight to about 70% by weight of the solids content of the sizing composition.

In one embodiment, for instance, the latent coupling agent may be a blocked isocyanate. As used herein, the term “blocked isocyanate” refers to an isocyanate in which one or more of the isocyanate groups of an organic polyisocyanate have been reversibly reacted with a blocking agent. In this manner, the resulting blocked (partially or fully) isocyanate groups are stable to active hydrogens at ambient temperature but can become deblocked at elevated temperatures so that they are reactive with active hydrogens, such as, for example, at temperatures between about 90° C. to about 210° C., in some embodiments between about 105° C. to about 180° C., and in some embodiments, between about 125° C. to about 170° C. Representative examples of suitable organic polyisocyanates include aliphatic isocyanates (e.g., trimethylene diisocyanate, tetramethylene diisocyanate, hexamethylene diisocyanate, butylidene diisocyanate, etc.); (cyclo)aliphatic isocyanates (e.g., isophorone diisocyanate (IPDI), 4,4′-diisocyanato-dicyclohexylmethane (HMDI), etc.); aromatic isocyanates (e.g., p-phenylene diisocyanate); aliphatic-aromatic isocyanates (e.g., 4,4′-diphenylene methane diisocyanate, 2,4- or 2,6-tolylene diisocyanate, etc.); as well as mixtures thereof. Representative examples of suitable blocking agents include, but are not limited to, oximes, such as methyl ethyl ketoxime, acetone oxime and cyclohexanone oxime; lactams, such as epsilon-caprolactam; alcohols; malonic esters; alkyl acetoacetates, triazoles; pyrazoles; phenols; amines, such as benzyl t-butylamine; as well as mixtures thereof. In one embodiment, the blocked isocyanate is a blocked cycloaliphatic polyisocyanate.

Other functionalized compounds may also be contained in the sizing composition. The functionalized compound may include polymers that contain an anhydride and/or carboxylic functionality. Examples of such polymers may include, for instance, a copolymer of ethylene-maleic anhydride, butadiene-maleic anhydride, isobutylene-maleic anhydride acrylate-maleic anhydride, polyacrylic acid, etc. When employed, such anhydride-and/or carboxylic-functionalized polymers may constitute from about 5 wt. % to about 60 wt. %, in some embodiments from about 10 wt. % to about 40 wt. %, and in some embodiments, from about 15 wt. % to about 30 wt. % of the solids content of the sizing composition (i.e., excluding water). Other functionalized polymers may also be employed, either alone or in combination with polymers that contain an anhydride and/or carboxylic functionality. In certain embodiments, for example, an epoxy-functionalized polymer may be employed, such as epoxy phenol novolac (EPN), epoxy cresol novolac (ECN), etc. When employed, such epoxy-functionalized polymers may constitute from about 30 wt. % to about 90 wt. %, in some embodiments from about 40 wt. % to about 80 wt. %, and in some embodiments, from about 50 wt. % to about 70 wt. % of the solids content of the sizing composition (i.e., excluding water). In certain embodiments, combinations of such functionalized polymers may also be employed. In fact, it is believed that a dense crosslinked sheath can formed around the inorganic fibers by reaction of epoxy groups with maleic anhydride and/or carboxylic groups.

The sizing composition may be applied to the surface of the inorganic fibers in a variety of different ways. For example, the sizing composition may be applied as the fibers are formed out of a bushing. The entire composition may also be applied to the fibers in a single step, or one or more components of the sizing composition may be applied separately. In one embodiment, for example, a two-stage application process may be employed in which a polymer containing an anhydride and/or carboxylic acid functionality is applied in a first stage and a polymer containing an epoxy functionality is applied in a second stage. In this manner, the polymers may be crosslinked together only after application to the fiber surface. Other components of the sizing composition may be applied separately or in combination with one or both of the polymers. Notwithstanding the particular process employed, one or more solvents (e.g., water) may be added to the components of the sizing composition during application to aid in the coating process. Once coated, the fibers may be dried to remove the solvent. In this regard, the moisture content of the coated fibers is typically about 0.5 wt. % or less, in some embodiments about 0.2 wt. % or less, and in some embodiments about 0.1 wt. % or less. Likewise, the amount of the sizing composition employed is typically from about 0.3 wt. % to about 1.2 wt. %, in some embodiments from about 0.4 wt. % to about 1 wt. %, and in some embodiments, from about 0.5 wt. % to about 0.8 wt. % based on the total weight of the coated fibers.

The reinforcing fibers may be compounded into the polyoxymethylene matrix, for example in an extruder or kneader. However, the reinforcing fibers may also advantageously take the form of continuous-filament fibers sheathed or impregnated with the polyoxymethylene molding composition in a process suitable for this purpose, and then processed or wound up in the form of a continuous strand, or cut to a desired pellet length so that the fiber lengths and pellet lengths are identical. An example of a process particularly suitable for this purpose is the pultrusion process.

Fiber diameters can vary depending upon the particular fiber used and whether the fiber is in either a chopped or a continuous form. The fibers, for instance, can have a diameter from about 5 μm to about 100 μm, such as from about 5 μm to about 50 μm, such as from about 5 μm to about 15 μm.

In an alternative embodiment, the reinforcing fibers do not include a reactive sizing composition containing a latent coupling agent and the composition instead includes a coupling agent-enriched polymer, such as a polyurethane polymer, that contains functional groups which causes crosslinking to occur between the reinforcing fibers or the sizing composition on the reinforcing fibers and the polyoxymethylene polymer. The functional groups contained in the coupling agent-enriched polyurethane polymer can be functional groups that comprise a bi-functional crosslinker for producing linear crosslinks and/or can comprise tri-functional crosslinks for forming a crosslinking network within the polymer matrix. In one embodiment, the coupling agent-enriched polyurethane polymer comprises a masterbatch of a thermoplastic polyurethane polymer combined with a coupling agent containing bi-functional and/or tri-functional crosslinking groups.

The polyurethane polymer can comprise a thermoplastic polyurethane polymer or TPU.

The thermoplastic polyurethane polymer is typically selected from the group of polyester-based thermoplastic polyurethane polymers, polyether-based thermoplastic polyurethane polymers, and combinations thereof. For purposes of the subject disclosure, a “polyester-based” thermoplastic polyurethane polymer is a thermoplastic polyurethane polymer that includes at least two ester groups present therein and/or is formed from a reactant that includes a polyester bond. Likewise, also for purposes of the instant application, a “polyether-based” thermoplastic polyurethane polymer is a thermoplastic polyurethane polymer that includes at least two ether groups present therein and/or is formed from a reactant that includes a polyether bond. It is to be appreciated that for both polyester-based and polyether-based thermoplastic polyurethane polymers, reactants can be used to form the thermoplastic polyurethane polymers that do not include polyester or polyether groups therein. Further, it is also to be appreciated that suitable thermoplastic polyurethane polymers for purposes of this disclosure are not limited to polyester-based or polyether-based thermoplastic polyurethane polymers, and that other thermoplastic polyurethane polymers may also be suitable that do not include ether or ester groups present therein.

The thermoplastic polyurethane polymer typically comprises the reaction product of a polyol and an isocyanate. In one embodiment, the thermoplastic polyurethane polymer is the polyester-based thermoplastic polyurethane polymer and includes the reaction product of a polyester polyol and an isocyanate. Suitable polyester polyols may be produced from a reaction of a dicarboxylic acid and a glycol having at least one primary hydroxyl group. Suitable dicarboxylic acids may be selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols that are suitable for use in producing the polyester polyols may be selected from the group of, but are not limited to, ethylene glycol, butylene glycol, hexanediol, bis (hydroxymethylcyclohexane), 1,4-butanediol, diethylene glycol, 2,2-dimethyl propylene glycol, 1,3-propylene glycol, and combinations thereof.

In a further embodiment, the thermoplastic polyurethane polymer is a polyether-based thermoplastic polyurethane polymer and includes the reaction product of a polyether polyol and an isocyanate. Suitable polyether polyols may be selected from the group of, but are not limited to, polytetramethylene glycol, polyethylene glycol, polypropylene glycol, and combinations thereof.

In an alternative embodiment, the thermoplastic polyurethane polymer further includes the reaction product of a chain extender, in addition to the polyester polyols or polyether polyols in the polyester-based or polyether-based thermoplastic polyurethane polymers, respectfully. In yet another alternative embodiment, the thermoplastic polyurethane polymer may comprise the reaction product of the chain extender and the isocyanate in the absence of polyester polyols and/or polyether polyols. Suitable chain extenders may be selected from the group of, but are not limited to, diols including ethylene glycol, propylene glycol, butylene glycol, 1,4-butanediol, butenediol, butynediol, xylylene glycols, amylene glycols, 1,4-phenylene-bis-beta-hydroxy ethyl ether, 1,3-phenylene-bis-beta-hydroxy ethyl ether, bis-(hydroxy-methyl-cyclohexane), hexanediol, and thiodiglycol; diamines including ethylene diamine, propylene diamine, butylene diamine, hexamethylene diamine, cyclohexalene diamine, phenylene diamine, tolylene diamine, xylylene diamine, 3,3′-dichlorobenzidine, and 3,3′-dinitrobenzidine; alkanol amines including ethanol amine, aminopropyl alcohol, 2,2-dimethyl propanol amine, 3-aminocyclohexyl alcohol, and p-aminobenzyl alcohol; and combinations of any of the aforementioned chain extenders.

Typically, the polyol used to form the thermoplastic polyurethane polymer has a weight average molecular weight of from 600 to 2,500 g/mol. It is to be appreciated that when multiple polyols are used to form the thermoplastic polyurethane polymers, each of the polyols typically has a weight average molecular weight within the above range. However, the polyol used to form the thermoplastic polyurethane polymer is not limited to this molecular weight range.

The thermoplastic polyurethane polymer is enriched with a coupling agent through melt blending, bonding, or the like. The coupling agent produces functional groups that can couple the glass fibers or sizing composition on the glass fibers to the polyoxymethylene polymer. As described above, in one embodiment, the coupling agent can form crosslinks that are either linear or form a network. The coupling agent can be present in the coupling agent-enriched thermoplastic polyurethane polymer generally in an amount less than about 80% by weight, such as in an amount less than about 70% by weight, such as in an amount less than about 60% by weight, such as in an amount less than about 50% by weight, such as in an amount less than about 40% by weight, such as in an amount less than about 30% by weight, and in an amount greater than about 20% by weight, such as in an amount greater than about 25% by weight, such as in an amount greater than about 35% by weight, such as in an amount greater than about 45% by weight, such as in an amount greater than about 50% by weight. The remainder of the composition can comprise the thermoplastic polyurethane polymer.

The coupling agent contained in the coupling agent-enriched thermoplastic polyurethane polymer can comprise any suitable coupling agent capable of bonding with the polyoxymethylene polymer and the glass fibers or sizing composition contained on the glass fibers. In one aspect, the coupling agent comprises an isocyanate or contains isocyanate functional groups. The isocyanate can comprise an aliphatic isocyanate or an aromatic isocyanate.

The isocyanate may include, but is not limited to, monoisocyanates, diisocyanates, polyisocyanates, biurets of isocyanates and polyisocyanates, isocyanurates of isocyanates and polyisocyanates, and combinations thereof. In one embodiment, the isocyanate includes an n-functional isocyanate. In this embodiment, n is a number typically from 2 to 5, more typically from 2 to 4, and most typically from 2 to 3. It is to be understood that n may be an integer or may have intermediate values from 2 to 5. The isocyanate may include an isocyanate selected from the group of aromatic isocyanates, aliphatic isocyanates, and combinations thereof. In another embodiment, the isocyanate includes an aliphatic isocyanate such as hexamethylene diisocyanate, H12MDI, and combinations thereof. If the isocyanate includes an aliphatic isocyanate, the isocyanate may also include a modified multivalent aliphatic isocyanate, i.e., a product which is obtained through chemical reactions of aliphatic diisocyanates and/or aliphatic polyisocyanates. Examples include, but are not limited to, ureas, biurets, allophanates, carbodiimides, uretonimines, isocyanurates, urethane groups, dimers, trimers, and combinations thereof. The isocyanate may also include, but is not limited to, modified diisocyanates employed individually or in reaction products with polyoxyalkyleneglycols, diethylene glycols, dipropylene glycols, polyoxyethylene glycols, polyoxypropylene glycols, polyoxypropylene polyoxyethylene glycols, polyesterols, polycaprolactones, and combinations thereof.

Alternatively, the isocyanate may include an aromatic isocyanate. If the isocyanate includes an aromatic isocyanate, the aromatic isocyanate may correspond to the formula R′(NCO)_{z} wherein R′ is aromatic and z is an integer that corresponds to the valence of R′. Typically, z is at least two. Suitable examples of aromatic isocyanates include, but are not limited to, tetramethylxylylene diisocyanate (TMXDI), 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4-and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. Alternatively, the aromatic isocyanate may include a triisocyanate product of m-TMXDI and 1,1,1-trimethylolpropane, a reaction product of toluene diisocyanate and 1,1,1-trimethyolpropane, and combinations thereof. In one embodiment, the isocyanate includes a diisocyanate selected from the group of methylene diphenyl diisocyanate, toluene diisocyanate, hexamethylene diisocyanate, H12MDI, and combinations thereof.

In one aspect, the coupling agent can comprise an isocyanate prepolymer. The isocyanate component of the cross-linking agent may include an isocyanate prepolymer. The isocyanate prepolymer is typically a reaction product of an isocyanate and a polyol and/or a polyamine. The isocyanate used in the prepolymer can be any isocyanate as described above. The polyol used to form the prepolymer is typically selected from the group of ethylene glycol, diethylene glycol, propylene glycol, dipropylene glycol, butane diol, glycerol, trimethylolpropane, triethanolamine, pentaerythritol, sorbitol, biopolyols, and combinations thereof. The polyamine used to form the prepolymer is typically selected from the group of ethylene diamine, toluene diamine, diaminodiphenylmethane and polymethylene polyphenylene polyamines, aminoalcohols, and combinations thereof. Examples of suitable aminoalcohols include ethanolamine, diethanolamine, triethanolamine, and combinations thereof.

The coupling agent-enriched thermoplastic polyurethane polymer can also contain a mixture of different coupling agents. For instance, in one embodiment, the coupling agent-enriched thermoplastic polyurethane polymer can contain diphenylmethane-4,4′-disocyanate in combination with another isocyanate, such as a polyisocyanate or an isocyanate prepolymer.

The amount the coupling agent-enriched thermoplastic polyurethane polymer is incorporated into the polymer composition of the present disclosure depends upon various factors including the amount of glass fibers, the type of polyoxymethylene polymer incorporated into the composition, the amount of coupling agent contained within the thermoplastic polyurethane polymer, and the like. In one aspect, the polymer composition contains the coupling agent-enriched thermoplastic polyurethane polymer in an amount greater than about 0.1% by weight, such as in an amount greater than about 0.25% by weight, such as in an amount greater than about 0.5% by weight, such as in an amount greater than about 0.75% by weight, such as in an amount greater than about 1% by weight, such as in an amount greater than about 1.5% by weight, such as in an amount greater than about 2% by weight, such as in an amount greater than about 2.5% by weight, such as in an amount greater than about 3% by weight, such as in an amount greater than about 3.5% by weight, such as in an amount greater than about 4% by weight, and in an amount less than about 20% by weight, such as in an amount less than about 15% by weight, such as in an amount less than about 10% by weight, such as in an amount less than about 8% by weight, such as in an amount less than about 6% by weight, such as in an amount less than about 5% by weight, such as in an amount less than about 4.5% by weight, such as in an amount less than about 4% by weight, such as in an amount less than about 3.5% by weight.

The polymer composition of the present disclosure containing the polyoxymethylene polymer can be formulated with reinforcing fibers that contain the reactive sizing composition as described above alone or in combination with a coupling agent-enriched thermoplastic polyurethane polymer. In accordance with the present disclosure, the polymer composition can contain the reactive sizing composition on the reinforcing fibers and/or the coupling agent-enriched thermoplastic polyurethane polymer without also containing any other coupling agents. For instance, the polymer composition can be formulated such that the composition does not contain any free isocyanate compounds. A free isocyanate compound, as used herein, refers to an isocyanate compound that is not reacted with another component, not contained in a sizing composition, or combined with a polymer component.

The polymer composition of the present disclosure may also contain other known additives such as, for example, antioxidants, formaldehyde scavengers, acid scavengers, UV stabilizers or heat stabilizers. In addition, the compositions can contain processing auxiliaries, for example adhesion promoters, lubricants, nucleants, demolding agents, fillers, or antistatic agents and additives which impart a desired property to the compositions and articles or parts produced therefrom.

In one embodiment, a formaldehyde scavenger, such as a nitrogen-containing compound, may be present. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Other particularly advantageous compounds are triamino-1,3,5-triazine (melamine) and its derivatives, such as melamine-formaldehyde condensates and methylol melamine. Oligomeric polyamides are also suitable in principle for use as formaldehyde scavengers. The formaldehyde scavenger may be used individually or in combination.

Further, the formaldehyde scavenger may be a guanamine compound which may include an aliphatic guanamine-based compound, an alicyclic guanamine-based compound, an aromatic guanamine-based compound, a hetero atom-containing guanamine-based compound, or the like.

The formaldehyde scavenger may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a nucleant may be present. The nucleant may increase crystallinity and may comprise an oxymethylene terpolymer. In one particular embodiment, for instance, the nucleant may comprise a terpolymer of butanediol diglycidyl ether, ethylene oxide, and trioxane. The nucleant may be present in the composition in an amount of at least about 0.01 wt. %, such as at least about 0.05 wt. %, such as at least about 0.1 wt. % and less than about 2 wt. %, such as less than about 1.5 wt. %, such as less than about 1 wt. %, wherein the weight is based on the total weight of the respective polymer composition.

In one embodiment, an antioxidant, such as a sterically hindered phenol, may be present. Examples which are available commercially, are pentaerythrityl tetrakis[3-(3,5-di-tert-butyl-4-hydroxyphenyl)propionate], triethylene glycol bis[3-(3-tert-butyl-4-hydroxy-5-methylphenyl)propionate], 3,3′-bis [3-(3,5-di-tert-butyl-4-hydroxyphenyl)propionohydrazide], and hexamethylene glycol bis[3-(3,5-di-tert-butyl-4-hydroxyphenyl)propionate]. The antioxidant may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lights stabilizers, such as sterically hindered amines, may be present. Hindered amine light stabilizers that may be used include oligomeric hindered amine compounds that are N-methylated. For instance, hindered amine light stabilizer may comprise a high molecular weight hindered amine stabilizer. The light stabilizers, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, an ultraviolet light stabilizer may be present. The ultraviolet light stabilizer may comprise a benzophenone, a benzotriazole, or a benzoate. The UV light absorber, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lubricants may be present. The lubricant may comprise a polymer wax composition. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. In another embodiment, a fatty acid amide such as ethylene bis(stearylamide) may be present. Lubricants may generally be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a colorant may be present. Colorants that may be used include any desired inorganic pigments, such as titanium dioxide, ultramarine blue, cobalt blue, and other organic pigments and dyes, such as phthalocyanines, anthraquinnones, and the like. Other colorants include carbon black or various other polymer-soluble dyes. The colorant may be present in the composition in an amount of at least about 0.01 wt. %, such as at least about 0.05 wt. %, such as at least about 0.1 wt. % and less than about 5 wt. %, such as less than about 2.5 wt. %, such as less than about 1 wt. %, wherein the weight is based on the total weight of the respective polymer composition.

In one embodiment, an acid scavenger may be present. The acid scavenger may comprise, for instance, an alkaline earth metal salt. For instance, the acid scavenger may comprise a calcium salt, such as a calcium citrate. The acid scavenger may be present in an amount of at least about 0.001 wt. %, such as at least about 0.005 wt. %, such as at least about 0.0075 wt. % and less than about 1 wt. %, such as less than about 0.75 wt. %, such as less than about 0.5 wt. %, wherein the weight is based on the total weight of the respective polymer composition.

The compositions of the present disclosure can be compounded and formed into a polymer article using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 100 to 280° C., such as from 120 to 260° C., such as from 140 to 240° C. or 180 to 220° C.

After extrusion, the compositions may be formed into pellets. The pellets can be molded into polymer articles by techniques known in the art such as injection molding, thermoforming, blow molding, rotational molding and the like. According to the present disclosure, the polymer articles demonstrate excellent tribological behavior and mechanical properties. Consequently, the polymer articles can be used for several applications where low wear and excellent gliding properties are desired.

The polymer composition of the present disclosure can be used to produce various and numerous different types of polymer articles. The polymer articles can be used in all different types of industries. For instance, the polymer composition of the present disclosure can be used to produce consumer appliance parts, automotive parts, industrial parts, and the like. For instance, molded articles made according to the present disclosure include gears, levers, cams, rollers, pulleys, latches, conveyor components, and housings. An almost limitless variety of polymer articles may be formed from the polymer compositions of the present disclosure.

The polymer composition can have unexpectedly high flow characteristics that allow the composition to be used to produce articles with complicated shapes and/or articles with very thin walls. In one embodiment, for instance, the polymer composition can be used to produce electrical or computer components. For instance, the polymer composition can be used to produce computer key board components. Alternatively, the polymer composition can be used to produce connectors. The connector, for instance, may contain insertion passageways that are configured to receive terminals or contact pins. These passageways are defined by opposing walls, which can be very thin and have small dimensional tolerance.

As described above, polymer compositions of the present disclosure have excellent formaldehyde emission properties even when containing substantial amounts of reinforcing fibers. For example, the polymer composition of the present disclosure can emit less than about 10 mg/kg, such as less than about 9 mg/kg, such as less than about 8 mg/kg, such as less than about 7 mg/kg, such as less than about 6 mg/kg, such as less than about 5 mg/kg, such as less than about 4 mg/kg, such as less than about 3 mg/kg, such as less than about 2 mg/kg of formaldehyde when tested according to Test VDA 275.

The polymer composition of the present disclosure also has excellent mechanical properties. For example, when tested according to ISO Test No. 527, the polymer composition may have a tensile modulus of greater than about 5,000 MPa, such as greater than about 6,000 MPa, such as greater than about 7,000 MPa, such as greater than about 8,000 MPa. The tensile modulus is generally less than about 50,000 MPa. In one embodiment, the stress at break can be greater than about 100 MPa, such as greater than about 120 MPa, such as greater than about 135 MPa, such as greater than about 140 MPa, such as greater than about 145 MPa, such as greater than about 150 MPa.

The polymer composition can exhibit a notched Charpy impact strength at 23° C. of greater than about 9 KJ/m², such as greater than about 9.3 KJ/m², such as greater than about 10 KJ/m², such as greater than about 10.8 KJ/m². When a polyurethane polymer is present, the notched Charpy impact strength can be higher, such as greater than about 11 KJ/m², such as greater than about 13 KJ/m², such as greater than about 15 KJ/m², such as greater than about 16 KJ/m², such as greater than about 17 KJ/m², such as greater than about 18 KJ/m, such as greater than about 19 KJ/m². The notched Charpy impact strength is generally less than about 30 KJ/m².

The polymer composition can exhibit a melt volume rate of from about 0.5 cm³/10 min to about 10 cm³/10 min in certain embodiments. In one embodiment, the melt volume rate is greater than about 0.7 cm³/10 min, such as greater than about 1 cm³/10 min, such as greater than about 1.5 cm³/10 min, such as greater than about 1.8 cm³/10 min, such as greater than about 2 cm³/10 min, such as greater than about 2.2 cm³/10 min, such as greater than about 2.5 cm³/10 min, such as greater than about 2.8 cm³/10 min. Melt volume rate can be measured at 190° C. and at a load of 2.16 kilograms. The melt volume rate is generally less than about 30 cm³/10 min, such as less than about 20 cm³/10 min.

The present disclosure may be better understood with reference to the following examples.

### TEST METHODS

The testing of polymer compositions made according to the present disclosure are conducted according to the following tests.
MVR (190° C.; 2.16 kg): ISO 1133;
Charpy notched impact strength: determined at 23° C. according to ISO 179- 1/1eA (CNI);
Elongation at break, stress at break and tensile modulus have been determined according to ISO 527;
Formaldehyde emission has been determined according to VDA 275 (Verband der Automobilindustrie e.V. (VDA), July 1994);
Portion of terminal OH groups in POM has been determined as described in K. Kawaguchi, E. Masuda, Y. Tajima, Journal of Applied Polymer Science, Vol. 107, 667-673 (2008).

### Example No. 1

Glass fiber-filled polyoxymethylene polymer compositions were formulated in accordance with the present disclosure. In particular, the polyoxymethylene polymer compositions contained a polyoxymethylene polymer containing 3.4% by weight dioxolane comonomer, a melt flow rate of 9 g/10 min., and terminal hydroxyl groups in an amount of greater than 20 mmol/kg. In this example, the polyoxymethylene polymer was combined with glass fibers containing a reactive sizing composition. The sizing composition contained a latent coupling agent. The latent coupling agent was a blocked isocyanate. The glass fibers were added in an amount of 25% by weight. For purposes of comparison, a polymer composition was formulated containing 25% glass fibers that did not contain a latent coupling agent.

More particularly, the following polymer compositions were formulated:

| | Sample | Sample | Sample |
|---|---|---|---|
| Component | No. 1 | No. 2 | No. 3 |
| Polyoxymethylene | 73.99 | 73.49 | 73.99 |
| polymer | | | |
| Glass fiber containing | 25.00 | 25.00 | — |
| blocked isocyanate | | | |
| Glass fiber without | — | — | 25.00 |
| blocked isocyanate | | | |
| Nucleating Agent | 0.5 | 0.5 | 0.5 |
| Pentaerythritol tetrakis(3- | 0.4 | 0.4 | 0.4 |
| (3,5-di-tert-butyl-4- | | | |
| hydroxyphenyl)propionate) | | | |
| Melamine | 0.11 | 0.11 | 0.11 |
| MDI | — | 0.5 | — |

The above polymer compositions were rolled into plaques and tested for various properties. The following results were obtained:

| Test | Sample No. 1 | Sample No. 2 | Sample No. 3 |
|---|---|---|---|
| Formaldehyde | 10.7 | 27.6 | 3.4 |
| emission, Test | | | |
| VDA-275, (after 7 | | | |
| days) (ppm) | | | |
| Charpy notched | 12.8 | 12.6 | 8.8 |
| impact strength at | | | |
| 23° C. (kJ/m²) | | | |
| Tensile modulus | 8913 | 8976 | 8860 |
| (MPa) | | | |
| Break stress (MPa) | 152.5 | 151.5 | 138.9 |
| Break strain (%) | 4.1 | 4.3 | 2.9 |
| Melt flow rate | 3.0 | 2.0 | 2.8 |
| (g/10 min) | | | |

As shown above, adding a free isocyanate compound to Sample No. 2 did not improve properties and, in some cases, produced inferior results. The samples containing glass fibers in which the sizing agent contained a latent coupling agent displayed much better physical properties than Sample No. 3.

The samples were also observed for color after molding. Sample No. 2 displayed yellowing. Sample No. 1, on the other hand, produced samples with the least amount of yellowing.

### Example No. 2

Further polymer compositions were formulated in accordance with the present disclosure. In this example, the polymer compositions contained a coupling agent-enriched polyurethane thermoplastic elastomer. Two different thermoplastic elastomers were tested. One had tri-functional crosslinking properties and the other had bi-functional crosslinking properties. The same polyoxymethylene polymer used in Example No. 1 was used in this example. The following polymer compositions were formulated.

| | Sample | Sample | Sample | Sample | Sample | Sample | Sample |
|---|---|---|---|---|---|---|---|
| Component | No. 4 | No. 5 | No. 6 | No. 7 | No. 8 | No. 9 | No. 10 |
| Polyoxymethylene | 72.99 | 71.99 | 68.99 | 72.99 | 71.99 | 68.99 | 73.49 |
| polymer | | | | | | | |
| Glass fiber | 25.00 | 25.00 | 25.00 | 25.00 | 25.00 | 25.00 | 25.00 |
| Nucleating Agent | 0.5 | 0.5 | 0.5 | 0.5 | 0.5 | 0.5 | 0.5 |
| Pentaerythritol tetrakis | 0.4 | 0.4 | 0.4 | 0.4 | 0.4 | 0.4 | 0.4 |
| (3-(3,5-di-tert-butyl-4- | | | | | | | |
| hydroxyphenyl)propionate) | | | | | | | |
| Melamine | 0.11 | 0.11 | 0.11 | 0.11 | 0.11 | 0.11 | 0.11 |
| MDI | — | — | — | — | — | — | 0.5 |
| Coupling agent-enriched | 1.0 | 2.0 | 5.0 | — | — | — | — |
| polyurethane | | | | | | | |
| thermoplastic elastomer | | | | | | | |
| containing a tri-functional | | | | | | | |
| isocyanate | | | | | | | |
| Coupling agent-enriched | — | — | — | 1.0 | 2.0 | 5.0 | — |
| polyurethane | | | | | | | |
| thermoplastic elastomer | | | | | | | |
| containing a bi-functional | | | | | | | |
| isocyanate | | | | | | | |

As shown above, Sample No. 10 was formulated for purposes of comparison.

The above polymer compositions were molded into test plaques and tested for various properties. The following results were obtained:

| | Sample | Sample | Sample | Sample | Sample | Sample | Sample |
|---|---|---|---|---|---|---|---|
| Test | No. 4 | No. 5 | No. 6 | No. 7 | No. 8 | No. 9 | No. 10 |
| Formaldehyde | 4.5 | 4.4 | 6.6 | 2.8 | 2.6 | 3.1 | 3.6 |
| emission, Test VDA- | | | | | | | |
| 275, (after 7 days) | | | | | | | |
| (ppm) | | | | | | | |
| Charpy notched impact | 18.3 | 16.9 | 18.3 | 10.2 | 10.7 | 18.5 | 18.2 |
| strength at −30° C. | | | | | | | |
| (kJ/m²) | | | | | | | |
| Charpy notched impact | 14.8 | 18.7 | 20.3 | 11.2 | 12.1 | 19.4 | 20.7 |
| strength at 23° C. | | | | | | | |
| (kJ/m²) | | | | | | | |
| Tensile modulus (MPa) | 8935 | 8830 | 8497 | 8823 | 8736 | 8556 | 8920 |
| Break stress (MPa) | 153 | 152 | 143 | 138 | 139 | 144 | 156 |
| Break strain (%) | 3.6 | 3.8 | 3.8 | 2.6 | 2.7 | 3.3 | 3.8 |

As shown, polymer compositions formulated in accordance with the present disclosure performed as well or better than Sample No. 10 containing a free isocyanate compound. The compositions made according to the present disclosure unexpectedly displayed better formaldehyde emission results.

The plaques were also inspected for color. More yellowing was noticed when greater amounts of the thermoplastic polyurethane polymer were added.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polymer composition comprising:
a polyoxymethylene polymer containing terminal hydroxyl groups, the polyoxymethylene polymer being present in the polymer composition in an amount of at least about 30% by weight;
reinforcing fibers; and
(a) a reactive sizing composition present on a surface of the reinforcing fibers, the reactive sizing composition comprising a latent coupling agent that couples the reinforcing fibers to the terminal hydroxyl groups on the polyoxymethylene polymer;
(b) a crosslinking agent enriched polymer that comprises functional groups capable of coupling directly to the terminal hydroxyl groups on the polyoxymethylene polymer; or
(c) mixtures of (a) and (b).

2. A polymer composition as defined in claim 1, wherein the polyoxymethylene polymer contains terminal hydroxyl groups in an amount of at least about 10 mmol/kg.

3. A polymer composition as defined in claim 1, wherein the polyoxymethylene polymer is present in the polymer composition in an amount from about 40% by weight to about 90% by weight.

4. A polymer composition as defined in claim 1, wherein the reinforcing fibers include the reactive sizing composition, the latent coupling agent comprising a blocked isocyanate.

5. A polymer composition as defined in claim 1, wherein the reinforcing fibers comprise glass fibers, the reinforcing fibers being present in the polymer composition in an amount from about 5% by weight to about 50% by weight.

6. A polymer composition as defined in claim 1, wherein the polymer composition contains the crosslinking agent enriched polymer, the crosslinking agent enriched polymer comprising a polyurethane polymer.

7. A polymer composition as defined in claim 6, wherein the functional groups contained in the crosslinking agent enriched polymer comprise an isocyanate.

8. A polymer composition as defined in claim 6, wherein the polyurethane polymer is present in the polymer composition in an amount from about 0.01% by weight to about 25% by weight.

9. A polymer composition as defined in claim 6, wherein the polyurethane polymer is present in the polymer composition in an amount from about 0.1% by weight to about 10% by weight, such as from about 0.5% by weight to about 8% by weight.

10. A polymer composition as defined in claim 7, wherein the crosslinking agent enriched polymer forms crosslinks within the polymer composition.

11. A polymer composition as defined in claim 1, wherein the polymer composition further contains a formaldehyde scavenger.

12. A polymer composition as defined in claim 11, wherein the formaldehyde scavenger comprises melamine.

13. A polymer composition as defined in claim 1, wherein the polymer composition does not contain any other coupling agents.

14. A polymer composition as defined in claim 1, wherein the polymer composition does not contain a free polyisocyanate.

15. A polymer composition as defined in claim 4, wherein the polymer composition displays a notched Charpy impact strength at 23° C. of greater than about 9 kJ/m2.

16. A polymer composition as defined in claim 1, wherein the polymer composition displays a tensile modulus of greater than about 8,000 MPa.

17. A polymer composition as defined in claim 1, wherein the polymer composition displays a break stress of greater than about 140 MPa.

18. A polymer composition as defined in claim 1, wherein the polymer composition displays a melt flow rate of greater than about 2 g/10 min.

19. A polymer composition as defined in claim 1, wherein the polymer composition displays a formaldehyde emission when tested according to VDA Test 275 of less than about 7 ppm. 20 (Currently Amended) A polymer composition as defined in claim 7, wherein the polymer composition displays a notched Charpy impact strength resistance at 23° C. of greater than about 16 kJ/m2, and displays a notched Charpy impact strength resistance at −30° C. of greater than about 15 KJ/m2.

21. A process for producing molded articles comprising:
combining a polyoxymethylene polymer containing terminal hydroxyl groups with reinforcing fibers that are surface coated with a sizing composition and wherein
(a) the sizing composition comprises a latent coupling agent that couples the reinforcing fibers to the terminal hydroxyl groups on the polyoxymethylene polymer;
(b) a crosslinking agent enriched polymer that comprises functional groups capable of coupling directly to the terminal hydroxyl groups on the polyoxymethylene polymer is combined with the polyoxymethylene polymer and the reinforcing fibers; or
(c) wherein the polymer composition contains both (a) and (b); and
heating the polymer composition to a molten state and molding the composition into a polymer article, wherein, during the molding process, the terminal hydroxyl groups on the polyoxymethylene polymer are coupled to the sizing composition on the reinforcing fibers.
